(19) United States
(12) Patent Application Publication
(10) Pub. No.: US 2025/0247430 A1
(43) Pub. Date: Jul. 31, 2025

(54) MANAGING DATA PROCESSING SYSTEMS BASED ON MOTION DATA

(71) Applicant: Dell Products L.P., Round Rock, TX (US)

(72) Inventors: ABEYE TESHOME, Austin, TX (US); RICHARD M. TONRY, Georgetown, TX (US); BASSEM EL-AZZAMI, Austin, TX (US); ADOLFO SANDOR MONTERO, Pflugerville, TX (US); MOHIT ARORA, Frisco, TX (US); VINODKUMAR VASUDEV OTTAR, Mckinney, TX (US); LUIS ANTONIO VALENCIA REYES, Waxahachie, TX (US); RAJARAVI CHANDRA KOLLARAPU, Allen, TX (US); AMY CHRISTINE NELSON, Round Rock, TX (US)

(21) Appl. No.: 18/425,303

(22) Filed: Jan. 29, 2024

(51) Int. Cl. H04L 9/40; G06F 3/01

(52) U.S. Cl. CPC H04L 63/20; G06F 3/011

(57) ABSTRACT

Methods and systems for managing a data processing system are disclosed. Motion data for the data processing system may be usable to characterize a gait pattern for a person transporting the data processing system while the motion data is obtained. A management controller of the data processing system may perform a motion analysis process using the motion data to determine whether the gait pattern of the motion data is expected for the data processing system. If the gait pattern is not expected for the data processing system, then the data processing system may be subject to unauthorized transport, which may negatively impact the security of the data processing system. In response, the management controller may initiate performance of an action set in order to place the data processing system in an elevated security state.

### FIELD

Embodiments disclosed herein relate generally to managing data processing systems. More particularly, embodiments disclosed herein relate to systems and methods for managing security of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a data processing system. The data processing system may provide computer-implemented services. To provide the computer-implemented services, the data processing system may, for example, generate, store and/or access sensitive data. Therefore, to reduce the likelihood of the sensitive data being inadvertently exposed via the data processing system, a security framework may be implemented around the data processing system. For example, the security framework may implement physical and/or virtual access control measures for the data processing system.

The data processing system may include a portable device and therefore may be relocated over time in order to provide the computer-implemented services. Accordingly, the security framework may permit authorized transport of the data processing system. Authorized transport may include, for example, (i) transport by authorized persons (e.g., an authorized user of the data processing system), (ii) transport within specified geographical regions, (iii) transport within specified periods of time, and/or (iv) combinations thereof. However, the data processing system may be subject to unauthorized transport, which may place sensitive data of the data processing system at an increased risk of exposure. For example, the data processing system may be stolen and transported by an entity that is not authorized to access (e.g., transport) the data processing system.

To manage potential unauthorized access to the data processing system, motion data of the data processing system may be collected (e.g., recorded) and monitored. For example, the data processing system may include sensing components that measure and record movement of the data processing system. When the data processing system is being transported by a person, the recorded motion data may be used to characterize a gait pattern (e.g., a walking pattern) of the person, and the gait pattern may be used to determine (at least in part) whether transport of the data processing system is authorized. If unauthorized transport of the data processing system is detected, then the data processing system may be placed in an elevated security state to reduce potential negative impacts of the unauthorized transport (e.g., to prevent inadvertent exposure of sensitive data via the data processing system).

The data processing system may rely on its hardware resources (e.g., in-band components of the data processing system) to perform actions for detecting and/or responding to unauthorized transport of the data processing system. However, if the in-band components are unpowered, compromised, and/or otherwise unable to perform the actions, then the in-band components may not be relied upon to place the data processing system in an appropriate (e.g., elevated) security state. Thus, unauthorized transport of the data processing system may be managed using out-of-band components of the data processing system that may function independently from the in-band components. Accordingly, if the in-band components are unpowered, compromised, and/or otherwise unavailable, then the out-of-band components may remain available to prevent and/or mitigate potential negative effects of unauthorized transport of the data processing system, such as unauthorized access to the data processing system.

By doing so, embodiments disclosed herein may provide a system for managing a data processing system based on motion data for the data processing system. Out-of-band components of the data processing system may analyze the motion data to identify a gait pattern associated with (pedestrian) transport of the data processing system. When the gait pattern is unexpected for the data processing system, the out-of-band components may initiate performance of actions to protect the data processing system. The actions may include updating operation of the data processing system in accordance with its policies despite potentially unavailable in-band components of the data processing system.

In an embodiment, a computer-implemented method for managing a data processing system is provided. The method may include: obtaining motion data for the data processing system, the motion data being usable to characterize a gait pattern for a person transporting the data processing system while the motion data is obtained; and, performing, at least in part, by a management controller of the data processing system, a motion analysis process using the motion data to determine whether the gait pattern of the motion data is expected for the data processing system.

In a first instance of the performing of the motion analysis process where it is determined that the gait pattern is not expected for the data processing system, the method may include: identifying, by the management controller, a policy for the data processing system that, at least in part, governs operation of the data processing system; and, initiating, by the management controller, performance of an action set based on the policy to update the operation of the data processing system to place the data processing system in an elevated security state.

The method may further include, prior to obtaining the motion data and during a provisioning process for the data processing system: obtaining, by the data processing system, initial motion data for the data processing system while a person authorized to transport the data processing system is transporting the data processing system; providing, by the management controller and via an out-of-band communication channel and to a service system, the initial motion data; and, obtaining, by the management controller and via the out-of-band communication channel and from the service system, a gait signature, the gait signature being based on the initial motion data.

Performing the motion analysis process may include: obtaining the gait pattern based on the motion data; comparing the gait pattern to the gait signature for the data processing system identify a level of similarity between the gait pattern and the gait signature; making a determination regarding whether the gait pattern is expected for the data processing system based on the level of similarity; and, in a first instance where the level of similarity exceeds a similarity threshold, treating the gait pattern as unexpected.

The motion data may be obtained using at least one sensing component of the data processing system from a list of sensing components consisting of: an accelerometer; a gyroscope; a magnetometer; and a global positioning system sensor.

The action set may include disabling, by the management controller, a portion of hardware resources of the data processing system. The portion of the hardware resources may include a trusted platform module.

The action set may include disabling a piece of software hosted by hardware resources of the data processing system.

The action set may include providing, by the management controller and via an out-of-band communication channel and to a service system, a notification indicating that the gait pattern is unexpected. The notification may be provided while a portion of hardware resources of the data processing system are inoperable.

The policy may be obtained by the management controller via an out-of-band communication channel and from a service system tasked with managing policies for the data processing system.

When the data processing system is in the elevated security state, data previously accessible via the data processing system may be inaccessible via the data processing system.

The data processing system may include a network module adapted to separately advertise network endpoints for the management controller and hardware resources of the data processing system, the network endpoints being usable by a service system to address communications to the hardware resources and the management controller.

An out-of-band communication channel that services the management controller may run through the network module, and an in-band communication channel that services the hardware resources may also run through the network module.

The management controller and the network module may be on separate power domains from the hardware resources so that the management controller and the network module are operable while the hardware resources are inoperable. The motion analysis process may be performed while a portion of the hardware resources are inoperable due to being unpowered.

A non-transitory media may include instructions that when executed by a processor cause the computer-implemented method to be performed.

The data processing system may include the non-transitory media and a processor, and may perform the computer-implemented method when the computer instructions are executed by the processor.

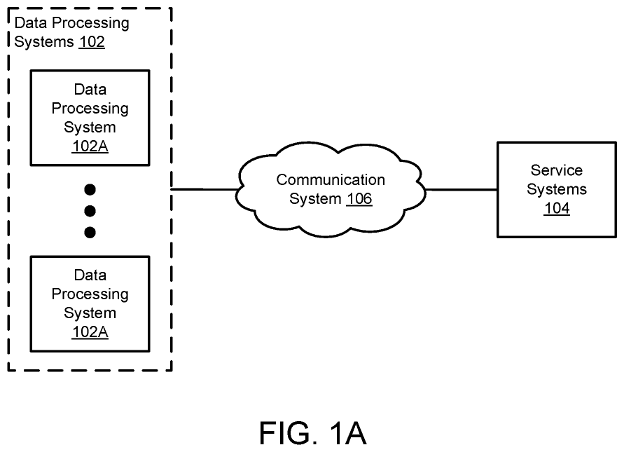

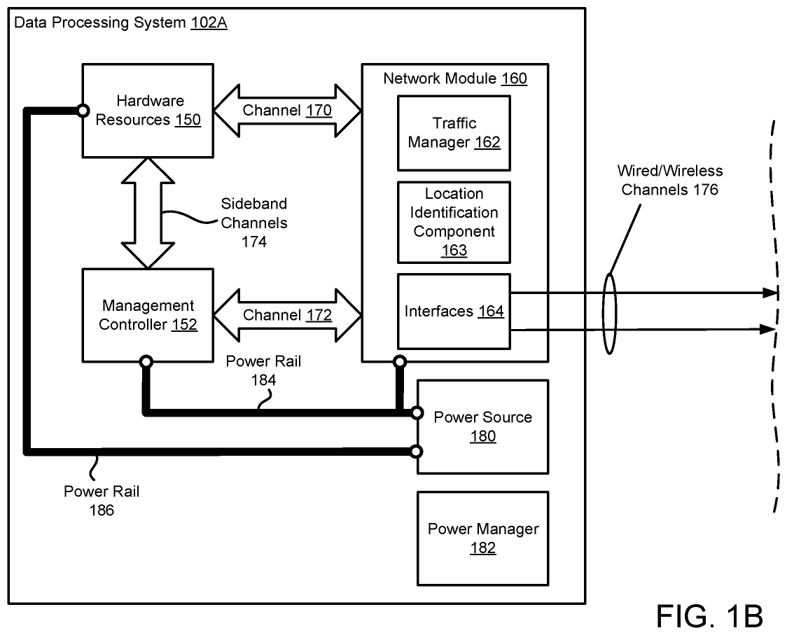

Turning to FIG. 1A, a block diagram illustrating a distributed system in accordance with an embodiment is shown. The (distributed) system shown in FIG. 1A may provide computer-implemented services. The computer-implemented services may include any type and quantity of services including, for example data services (e.g., data storage, access and/or control services), communication services (e.g., instant messaging services, video-conferencing services), and/or any other type of service that may be implemented with a computing device.

The computer-implemented services may be provided by one or more components of the system of FIG. 1A. For example, a data processing system (e.g., 102A) of data processing systems 102 may provide a portion of the computer-implemented services. In order to provide computer-implemented services, the data processing system may access, generate, provide, etc., sensitive data. Thus, to protect the sensitive data accessible via the data processing system, access to the data processing system may be limited to authorized users only.

The data processing system may include a portable device such as a smartphone, a laptop, etc., and may be transported (e.g., via pedestrian transport) between locations by the authorized user. However, an unauthorized user may gain physical access to the data processing system, which may negatively affect security of sensitive data accessible via the data processing system. For example, the data processing system may be stolen by a malicious party intending to access and/or exploit the sensitive data via the data processing system. Therefore, to protect the data processing system (e.g., from unauthorized use), operation of the data processing system may be limited when the data processing system is in the possession of an unauthorized user.

To identify whether the data processing system is in the possession of an unauthorized user (e.g., a person authorized to transport the data processing system), motion data for the data processing system may be recorded and analyzed while the data processing system is in transit. For example, while the data processing system is being transported by a person (e.g., a pedestrian), the motion data recorded by sensing components of the data processing system may be ascribed to the person. In particular, the motion data may be used to characterize a gait pattern that may be unique to the person transporting the data processing system. For example, the gait pattern may reflect identifying biometric characteristics of the person, such as height, weight, length of limbs, spinal alignment, posture, age, etc. Therefore, the motion data (e.g., the gait pattern derived from the motion data) may be used to authenticate the person transporting (e.g., that is in possession of) the data processing system.

To detect unauthorized transport (which may indicate the intention of unauthorized use) of the data processing system, the data processing system may perform processes to collect and analyze motion data while the data processing system is in transit. Based on the analysis of the motion data (e.g., if the person cannot be authenticated based on their gait pattern, then), the data processing system may respond by entering an elevated security state. For example, in order enter the elevated security state, operation of the data processing system may be updated (e.g., functionality of the data processing system may be limited).

In addition, to ensure timely detection and response to unauthorized transport of the data processing system, collection, analysis, and response processes may be managed using out-of-band components of the data processing system. For example, if in-band components (e.g., hardware resources) of the data processing system become unavailable (e.g., due to being unpowered, compromised, and/or otherwise inoperable), then the hardware resources may be unable to manage and/or perform the collection, analysis, and/or response processes in a timely and/or appropriate manner. By doing so, the likelihood of preventing unauthorized access to the data processing system may be increased.

In general, embodiments disclosed herein may provide methods, systems, and/or devices for managing a data processing system using motion data for the data processing system. The data processing system may include sensing components usable to obtain (e.g., record) motion data for the data processing system. The motion data may be managed (e.g., collected, analyzed) by out-of-band components of the data processing system that may operate independently from in-band components (e.g., hardware resources) of the data processing system. For example, the out-of-band components may analyze the motion data in order to identify (e.g., detect) unauthorized transport of the data processing system which may indicate the data processing system is being accessed by an unauthorized user. In response, the out-of-band components may also manage responses to the unauthorized transport by performing actions that may increase access security of the data processing system. By doing so, the actions may be performed in a timely and accurate manner without relying on potentially compromised or inoperable in-band components, thereby reducing the likelihood of the data processing system being subject to unauthorized access.

To perform the above-mentioned functionality, the system of FIG. 1A may include data processing systems 102, and/or service systems 104. Data processing systems 102, service systems 104, and/or any other type of devices not shown in FIG. 1A may perform all, or a portion of the computer-implemented services independently and/or cooperatively. Each of these components is discussed below.

Data processing systems 102 may include any number and/or type of data processing systems (e.g., 102A-102N). Any of data processing systems 102 may be operated by users and/or may provide computer-implemented services based on the users' operation. Any of data processing systems 102 may include in-band components (e.g., hardware resources) and out-of-band components (e.g., a management controller, a network module, etc.), and functionality that may allow the out-of-band components to (i) communicate with one another independently from the in-band components, (ii) perform operations independently from the in-band components, and/or (ii) communicate with remote systems independently from the in-band components. In addition, any of data processing systems 102 may include data collection components. For example, data processing system 102A may include sensing components usable to measure and/or collect motion data for data processing systems 102. For more information regarding components of data processing systems 102, refer to the discussion of FIG. 1B.

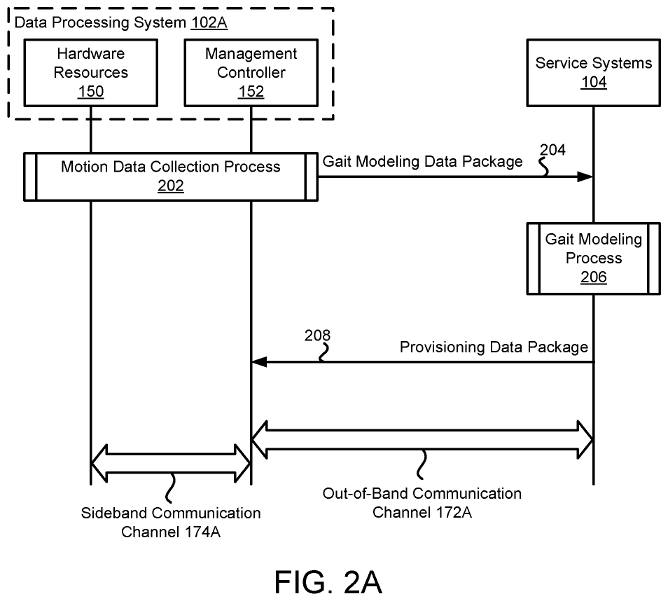

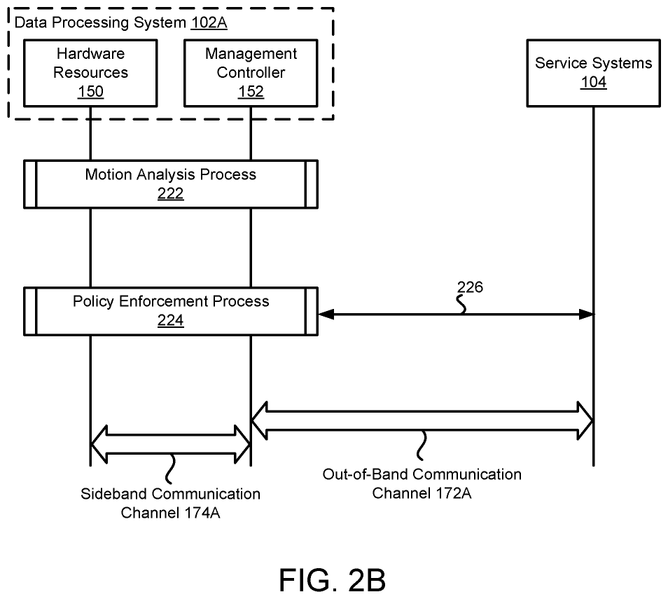

To perform its functionality, a data processing system (e.g., of 102) may (i) obtain motion data (e.g., from sensing components of the data processing system, while the data processing system is in transit), (ii) perform motion analysis processes using the motion data (e.g., to determine whether a gait pattern of the motion data is expected for the data processing system), (iii) provide information to a remote system (e.g., the motion data and/or results of the analysis of the motion data, via an out-of-band communication channel established between out-of-band components of the data processing system and the remote system), (iv) obtain information from the remote systems (e.g., provisioning data and/or other data for the data processing system, via the out-of-band communication channel), (v) initiate processes for updating operation of the data processing system (e.g., initiate performance of an action set) to enforce policies of the data processing system, and/or (vi) perform other actions (e.g., that may relate to managing the security state of the data processing system). Refer to the discussion of FIG. 2B for more information regarding managing operation of data processing systems based on motion data.

Service systems 104 may include any number and/or type of systems (e.g., devices) that may provide computer-implemented services. For example, one or more of service systems 104 may provide provisioning services, data management and/or analysis services (e.g., of data collected by components of data processing systems) 102, and/or policy management services for data processing systems (e.g., 102). For example, service systems 104 may provide the computer-implemented services for a data processing system by communicating (e.g., exchanging data) with the out-of-band components of the data processing system using out-of-band communication channels (e.g., bypassing any in-band components of data processing system 102).

To perform its functionality, a service system of service systems 104 may, for example, perform a provisioning process for a data processing system (e.g., of 102). To do so, the service system may (i) obtain information (e.g., initial motion data via an out-of-band communication channel) from a data processing system, (ii) perform modeling processes (e.g., a gait modeling process using the initial motion data, to obtain a gait signature for the data processing system), (iii) provide provisioning data to the data processing system (e.g., including the gait signature and/or policies for the data processing system, via the out-of-band communication channel). Refer to the discussion of FIG. 2A for more information regarding provisioning processes.

After performing a provisioning process for a data processing system of data processing systems 102, service systems 104 may continue to provide services for the data processing system. For example, service systems 104 may obtain and/or manage updated information for the data processing system, such as updated gait signatures and/or updated policies. Service systems 104 may provide the updated information to the data processing system upon request and/or automatically in order to support management of the data processing system.

Thus, the operation of a data processing system may be managed based on motion data for the data processing system. The data processing system may include sensing components usable to record and/or obtain motion data, and the data processing system may be provisioned with information usable to analyze the motion data. The motion data may be analyzed locally using out-of-band components of the data processing system instead of relying on potentially inoperable in-band components of the data processing system. Thus, unexpected motion data (e.g., indicating unauthorized transport of and/or potential unauthorized access to the data processing system) may be more likely to be detected and managed in a timely manner. By doing so, the data processing system may be more likely to be resistant to unauthorized access.

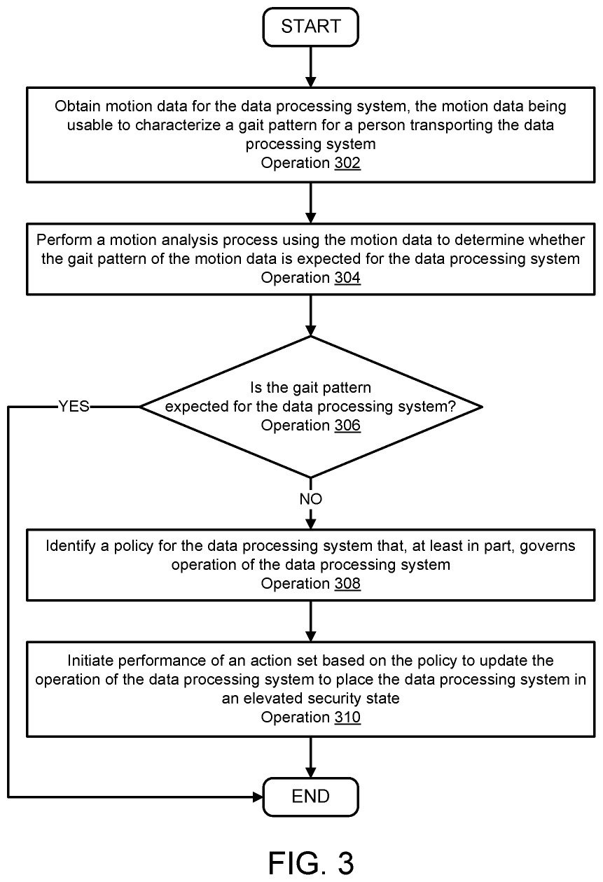

When providing their functionality, any of data processing systems 102 and/or service systems 104 may perform all, or a portion of the method shown in FIG. 3.

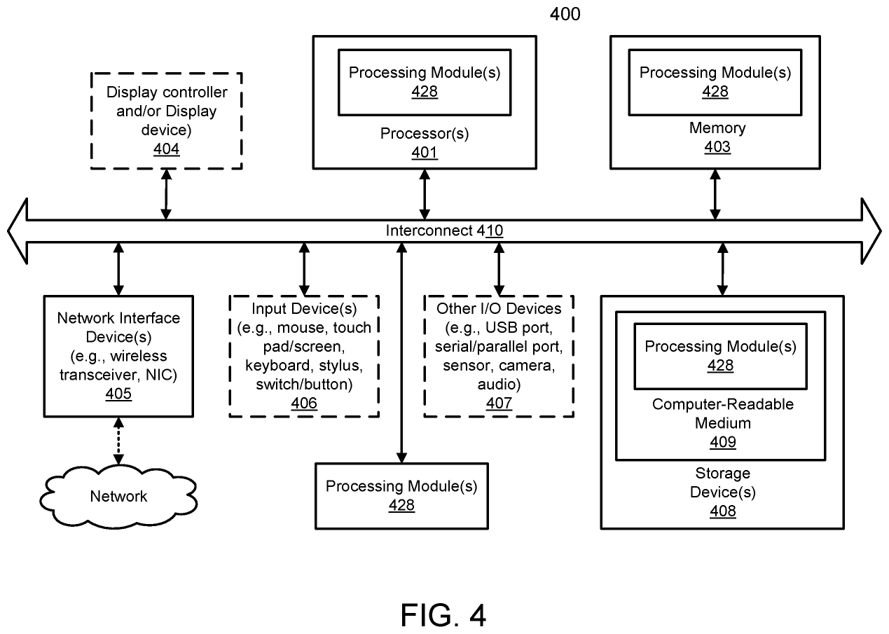

Any of (and/or components thereof) data processing systems 102 and/or service systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

In an embodiment, one or more of data processing systems 102 and/or service systems 104 are implemented using an internet of things (IoT) device, which may include a computing device. The IoT device may operate in accordance with a communication model and/or management model known to data processing systems 102, service systems 104, and/or other devices.

Any of the components illustrated in FIG. 1A may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and/or types of communication protocols (e.g., such as the internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102A shown in FIG. 1B may be similar to any of the computing devices shown in FIG. 1A (e.g., one of data processing systems 102).

To provide computer-implemented services, data processing system 102A may include any quantity of hardware resources 150. Hardware resources 150 may be in-band hardware components, and may include a processor operably coupled to memory, storage, and/or other hardware components, such as sensing components (not shown).

The sensing components may include sensors that measure movement and/or physical orientations of data processing system 102A. For example, the sensing components may include accelerometers, gyroscopes, magnetometers, global positioning system (GPS) sensors, and/or other types of sensors usable to measure movement of (and/or locate) an object. The sensing components may measure, for example, acceleration, angular velocity, orientation, and/or a physical location of data processing system 102A. The measured movement may be recorded by the sensing components and/or other components of data processing system 102A and may be referred to, in aggregate, as motion data.

For example, while data processing system 102A is being transported by a pedestrian, the sensing components (e.g., independently or in some combination) may measure various characteristics of a human walking pattern (e.g., human gait). The sensing components may be included as a portion of hardware resources 150 (e.g., in-band components) or may function separately from hardware resources 150 (e.g., as out-of-band components of data processing system 102A). Thus, motion data may be generated by (components of) data processing system 102A and may be stored by data processing system 102A (e.g., in storage of hardware resources 150).

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102A) to another device via any number of intermediate networks (e.g., via wired/wireless channels 176 that are part of the networks).

To reduce the likelihood of the applications and/or other in-band entities from being indirectly compromised, data processing system 102A may include management controller 152 and network module 160. Each of these components of data processing system 102A is discussed below.

Management controller 152 may be implemented, for example, using a system on a chip or other type of independently operating computing device (e.g., independent from the in-band components, such as hardware resources 150 of a host data processing system 102A). Management controller 152 may provide various management functionalities for data processing system 102A. For example, management controller 152 may monitor various ongoing processes performed by the in-band components, may manage power distribution, thermal management, and/or may perform other functions for managing data processing system 102A (e.g., enforce policies that may modify the operation of hardware resources 150).

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels). The sideband channels may be implemented using separate physical channels, and/or with a logical channel overlay over existing physical channels (e.g., logical division of in-band channels).

The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities. For example, management controller 152 may use sideband channels 174 to collect a portion of motion data for data processing system 102A and/or to initiate performance of actions that may update the operation of hardware resources 150 based on an analysis of collected motion data.

To reduce the likelihood of indirect compromise of an application hosted by hardware resources 150, management controller 152 may, for example, enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

For example, if hardware resources 150 are compromised as part of an attack (e.g., physically compromised due to data processing system 102A being stolen), then management controller 152 may autonomously initiate policy enforcement processes that may modify (e.g., limit) the operation of hardware resources 150 to place data processing system 102A in an elevated security state in order to mitigate an outcome of the attack.

To facilitate communication with other devices, data processing system 102A may include network module 160. Network module 160 may generate motion data (e.g., location data) and/or provide communication services for in-band components and out-of-band components (e.g., management controller 152) of data processing system 102A. To do so, network module 160 may include traffic manager 162, location identification component 163, and interfaces 164.

Traffic manager 162 may include functionality to (i) discriminate traffic directed to various network endpoints advertised by data processing system 102A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These component may support any number of wired/wireless channels 176.

To generate location data, network module 160 may include location identification component 163. Location identification component 163 may include a GPS receiver (e.g., for satellite-based geolocation), a cellular modem or chip (e.g., for cellular-based geolocation using a WWAN), sensors, and/or other types of geolocation components. Location identification component 163 may, for example, transmit and/or receive data across a network via interfaces 164 in order to generate (e.g., triangulate) a location of data processing system 102. The location data may be forwarded by traffic manager 162 to management controller 152 via an out-of-band communication channel (e.g., channel 172), bypassing potentially compromised and/or unavailable hardware resources 150.

Thus, location data for data processing system 102 may be generated and/or provided by network module 160 independently from hardware resources 150 (e.g., and software hosted by hardware resources 150). Network module 160 may provide location data generated by location identification component 163 to management controller 152 automatically based on a schedule, upon (automatic) detection of a change in location data (e.g., based on a displacement threshold), and/or upon obtaining a request for location data (e.g., from management controller 152). The location data may be used, for example, in part, to identify whether data processing system 102A is being transported (e.g., via pedestrian transport) and/or may be used to determine a trajectory (e.g., and predict a destination) for data processing system 102A.

Thus, from the perspective of an external device, the in-band components and out-of-band components of data processing system 102A may appear to be two independent network entities that may be independently addressable and/or otherwise unrelated to one another.

To facilitate management of data processing system 102A over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 is unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

Therefore, if hardware resources 150 become unavailable (e.g., due to being unpowered) then out-of-band components may remain powered, allowing (i) a portion of components of data processing system 102A to remain powered (e.g., sensing components, network module 160) in order to continue generating motion data for data processing system 102A, (ii) management controller 152 to obtain and/or to analyze data (e.g., the motion data), (iii) communications between management controller 152 and remote systems (e.g., via out-of-band communication channels, in order to exchange data with the remote systems), and/or (iv) management controller 152 to initiate and/or perform policy enforcement processes for data processing system 102A.

To implement the separate power domains, data processing system 102A may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) that may manage power from power source 180 may be supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, an interaction diagram in accordance with an embodiment is shown in each of FIGS. 2A-2B. The interaction diagrams may illustrate examples of how data may be obtained and used within the systems of FIGS. 1A-1B.

In the interaction diagrams, processes performed by and interactions between components of a system in accordance with an embodiment are shown. In the diagrams, components of the system are illustrated using a first set of shapes (e.g., 150, 152, etc.), located towards the top of each figure. Lines descend from these shapes. Processes performed by the components of the system are illustrated using a second set of shapes (e.g., 202, 206 etc.) superimposed over these lines.

Interactions (e.g., communication, data transmissions, etc.) between the components of the system are illustrated using a third set of shapes (e.g., 204, 208, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 204 may occur prior to the interaction labeled as 208. However, it will be appreciated that the processes and interactions may be performed in different orders, any may be omitted, and other processes or interactions may be performed without departing from embodiments disclosed herein.

The processes shown in FIGS. 2A-2B may be performed by any entity shown in the systems of FIGS. 1A-1B (e.g., a device similar to one of data processing systems 102, systems similar to service systems 104, etc.) and/or another entity without departing from embodiments disclosed herein.

Turning to FIG. 2A, a first interaction diagram in accordance with an embodiment is shown. The first interaction diagram may illustrate processes and interactions that may occur when providing provisioning services for a data processing system. For example, data processing system 102A may include a portable device that may provide computer-implemented services. As discussed with respect to FIGS. 1A-1B, data processing system 102A may include hardware resources 150 and management controller 152.

To be able to provide the computer-implemented services, data processing system 102A may undergo a provisioning process (e.g., an initial setup process). The provisioning process may be initiated by an authorized user of data processing system 102A (or an entity tasked with managing data processing system 102A with authority to initiate provisioning processes for data processing system 102A). The provisioning process may include obtaining initial motion data for data processing system 102A.

To obtain initial motion data, data processing system 102A may perform motion data collection process 202. Motion data collection process 202 may include recording (e.g., by sensing components and/or other components of data processing system 102A) motion data while a person authorized to transport data processing system 102A (e.g., the authorized user) is transporting data processing system 102A. For example, the authorized user may be instructed to perform a series of different movements during transport in order to obtain a variety of initial motion data (e.g., ambulation at various speeds, ascending and/or descending stairs, moving across different types of terrain and/or inclinations). Motion data collection process 202 may occur over a specified period of time.

During motion data collection process 202, management controller 152 may obtain the initial motion data independently from and/or in cooperation with hardware resources 150. For example, management controller 152 may retrieve a portion of the motion data from hardware resources 150 via sideband communication channel 174A. Management controller 152 may obtain other portions of motion data such as location data from a network module of data processing system 102A via an out-of-band communication channel (not shown).

Motion data collection process 202 may be performed for any number of authorized users of data processing system 102A (e.g., users authorized to transport data processing system 102A). Motion data collection process 202 may include obtaining (e.g., generating) a gait modeling data package. The gait modeling data package may include, for example, (i) initial motion data, (ii) identifying information (e.g., a device identifier for data processing system 102A, an identifier for the authorized user, etc.), and/or (iii) other data (e.g., authentication information, etc.).

At interaction 204, the gait modeling data package may be provided to service systems 104 by management controller 152. For example, the gait modeling data package may be generated and provided to service systems 104 via out-of-band communication channel 172A through (i) transmission via a message, (ii) storing in a storage with subsequent retrieval by service systems 104, (iii) a publish-subscribe system where service systems 104 subscribes to updates from management controller 152 thereby causing a copy of the gait modeling data package to be propagated to service systems 104, and/or (iv) other processes. By providing the gait modeling data package to service systems 104, service systems 104 may provide gait data management and/or gait analysis services.

Service systems 104 may obtain and authenticate management controller 152 and/or the gait modeling data package based on information included in the gait modeling data package. Once authenticated, service systems 104 may perform gait modeling process 206 using the initial motion data. Gait modeling process 206 may include analyzing the initial motion data in order to obtain a gait signature for the authorized user (e.g., the authorized user associated with the motion data).

Gait modeling process 206 may employ any type and/or number of gait analysis methods known in the art to identify gait parameters (e.g., a stride length, gait phase, gait asymmetry) of the gait signature. The gait signature may represent patterns of movement of the authorized user over time and may include aggregated statistics (e.g., averages over time) of the gait parameters. Gait modeling process 206 may be performed, at least in part, using inference models. For example, the inference models may be trained to infer a gait signature upon ingesting motion data.

The gait signature may include analysis parameters, such as thresholds (e.g., similarity thresholds). For example, a threshold value may be determined based on the quantity, quality and/or type of initial motion data used to obtain the gait signature (e.g., the threshold value may be related to the robustness of the gait signature). The analysis parameters, along with the gait signature may be used to analyze new motion data for data processing system 102A. Refer to the discussion of FIG. 2B for more information regarding motion data analysis.

Service system 104 may manage gait signatures for any number of users of any number of data processing systems. Therefore, the gait signature may be associated (e.g., tagged) with identifying information for data processing system 102A and/or the authorized user. Over time, the gait signature may be updated when new motion data is obtained for the authorized user via data processing system 102A (or other devices used by the authorized user). For example, the gait signature may be updated over time as more motion data for the authorized user is collected (e.g., to improve the robustness and/or accuracy of the gait signature). Updated gait signatures may be provided to (e.g., pushed out to) data processing system 102A by service systems 104 automatically, when requested (e.g., by data processing system 102A and/or other management devices) and/or based on an update schedule.

During the provisioning process for data processing system 102A, service systems 104 may obtain provisioning data for data processing system 102A. For example, service systems 104 may use device and/or user identifiers (e.g., included in the gait modeling data package) to identify portions of the provisioning data applicable to data processing system 102A. The provisioning data may include data usable to create and/or set up infrastructure of data processing system (e.g., software, configuration settings, user data, policies, and/or other data). For example, the provisioning data may include the gait signature, policies and/or data usable for monitoring (e.g., detecting) unauthorized transport of data processing system 102A.

Service system 104 may obtain (e.g., generate) a provisioning data package. The provisioning data package may include, for example, (i) the provisioning data, (ii) identifying information (e.g., a device identifier for data processing system 102A, an identifier for the authorized user, etc.), and/or (iii) other data (e.g., authentication information, etc.).

At interaction 208, the provisioning data package may be provided to management controller 152 by service systems 104. For example, the provisioning data package may be generated and provided to management controller 152 via out-of-band communication channel 172A through (i) transmission via a message, (ii) storing in a storage with subsequent retrieval by management controller 152, (iii) a publish-subscribe system where management controller 152 subscribes to updates from service systems 104 thereby causing a copy of the provisioning data package to be propagated to management controller 152, and/or (iv) other processes. By providing the provisioning data package to management controller 152, management controller 152 may complete the provisioning process.

Upon obtaining the provisioning data package, management controller 152 may perform additional actions to complete the provisioning process. For example, management controller 152 may communicate (e.g., exchange data) with hardware resources 150 via sideband communication channel 174A in order to install software, store data, update configuration settings, and/or perform other actions related to provisioning data processing system 102A. Once the provisioning process for data processing system 102A is complete, data processing system 102A may provide computer-implemented services according to its policies. For example, data processing system 102A may be provisioned to detect security threats, such as unauthorized transport of data processing system 102A.

Thus, as shown in the example of FIG. 2A, a data processing system may be provisioned to include a gait signature for a user of the data processing system. The gait signature may be derived (e.g., by a remote service system) based on initial motion data associated with the user. The gait signature may be used, in part, to detect security threats to the data processing system, such as unauthorized transport of, unauthorized possession of, and/or potential unauthorized access to the data processing system.

Turning to FIG. 2B, a second interaction diagram in accordance with an embodiment is shown. The second interaction diagram may illustrate processes and interactions that may occur in order to detect and/or manage unauthorized transport of a data processing system. For example, data processing system 102A may include a portable device that may provide computer-implemented services. As discussed, data processing system 102A may include hardware resources 150 and management controller 152.

Over time, a user of data processing system 102A may physically relocate data processing system 102A, causing components (e.g., sensing components of and/or a network module of data processing system 102A) to generate motion data for data processing system 102A. The motion data may be generated in real-time and/or may be stored by data processing system 102A (e.g., in hardware resources 150). As motion data is generated for data processing system 102A, the motion data may be analyzed.

To analyze the motion data, management controller 152 may initiate and/or perform motion analysis process 222. Motion analysis process 222 may include an ongoing process managed by management controller 152 and may be performed by management controller 152 independently of and/or in conjunction with a portion of hardware resources 150. Motion analysis process 222 may include collecting (e.g., obtaining) motion data for data processing system 102A.

To do so, management controller 152 may obtain portions of motion data such as location data from a network module of data processing system 102A via an out-of-band communication channel (not shown). Management controller 152 may obtain other portions of motion data from hardware resources 150 (e.g., sensing components) of data processing system 102A via sideband communication channel 174A. For example, management controller 152 may read motion data from storage and/or snoop activity of hardware resources 150 to obtain a portion of the motion data. The motion data collected during motion analysis process 222 may include additional data, such as aggregate summaries of the motion data, statistics generated based on the motion data, and/or other data that may be derived from or generated based on the motion data.

Motion analysis process 222 may be performed while a portion of hardware resources 150 are unpowered. For example, management controller 152 may manage power to a portion of unpowered hardware resources 150 in order to obtain motion data. Management controller 152 may obtain the motion data from compromised hardware resources 150 surreptitiously, reducing the likelihood of the motion data being intercepted and/or modified by an attacker intending to conceal transport of data processing system 102A.

Motion analysis process 222 may include analyzing the motion data to, for example, determine whether data processing system 102A is in motion (e.g., is being transported by the user). If data processing system 102A is in motion, then motion analysis process 222 may include (i) obtaining a gait pattern based on the motion data (e.g., obtain gait parameters based on an analysis of the motion data, which may be similar to analyses performed during gait modeling process 206 of FIG. 2A), (ii) comparing the gait pattern to a gait signature for an authorized user of data processing system 102A (e.g., to identify a level of similarity between the gait pattern and the gait signature), (iii) making a determination whether to treat the gait pattern as unexpected (or expected) based on the level of similarity and a similarity threshold.

For example, the level of similarity may include a value. A value that is inferior to (or equal to) the similarity threshold may indicate that the gait pattern and the gait signature may be considered similar or the same as one another; therefore, the gait pattern may be treated as expected for data processing system 102A. Otherwise, a value that exceeds the similarity threshold may indicate that the gait pattern and the gait signature may be considered different than one another; therefore, the gait pattern may be treated as unexpected for data processing system 102A. An unexpected gait pattern may indicate that the user transporting data processing system 102A includes an unauthorized user, which may be an indicator of attack or compromise of data processing system 102A.

Management controller 152 may initiate policy enforcement process 224 (e.g., upon determining that the gait pattern is unexpected). Policy enforcement process 224 may be performed directly by management controller 152 and/or in conjunction with hardware resources 150. For example, to perform the one or more actions, management controller 152 may communicate with hardware resources 150 over sideband communication channel 174A.

Policy enforcement process 224 may include identifying a policy for data processing system 102A that may be triggered by the unexpected gait pattern. The management controller 152 may identify a policy for data processing system 102A that, at least in part, governs operation of data processing system 102A (e.g., hardware resources 150). The policy may have been provided to data processing system 102A during a provisioning process similar to the provisioning process described with respect to FIG. 2A.

However, if data processing system 102A is unable to identify the policy or the policy is not up to date, then management controller 152 may request the policy (or an updated version of the policy) from service systems 104. For example, management controller 152 may obtain (e.g., generate) a policy request and provide the policy request to service systems 104 (e.g., at interaction 226, using methods similar to those described with respect to interaction 204 of FIG. 2A). In response, service systems 104 may locate and provide the requested policy to management controller 152 (e.g., at interaction 226, using methods similar to those described with respect to interaction 208 of FIG. 2A)

Policy enforcement process 224 may include updating operation of data processing system 102A in accordance with any number of (triggered) policies. To do so, policy enforcement process 224 may include initiating performance of one or more actions of an action set. The action set may be based on the policy. For example, the policy may specify that, while an unexpected gait pattern is detected, a portion of functionality of data processing system 102A is to be limited. The action set may include, for example, (i) instructions for disabling a portion of hardware resources 150 (e.g., a trusted platform module (TPM)), (ii) instructions for disabling a piece of software hosted by hardware resources 150, and/or (iii) instructions for other actions that my update operation of data processing system 102A to conform with a policy thereof.

Performing (one or more actions of) the action set may include, for example, (i) disabling (or enabling) one or more of hardware resources 150, (ii) disabling (or enabling) one or more pieces of software hosted by hardware resources 150, (iii) modifying authentication requirements (e.g., for access to a portion of functionality of data processing system 102A), (iv) removing a portion of data stored by data processing system 102A, (v) modifying the boot process for data processing system 102A, and/or (vi) other actions that my result in updated operation of data processing system 102A.

Disabling or enabling hardware and/or software may include, for example, encrypting portions of data stored by data processing system 102A, limiting the use of applications (e.g., or a portion of functionality of the applications) hosted by hardware resources 150. For example, management controller 152 may disable all functionality of data processing system 102A (e.g., prevent hardware resources 150 from being powered), and/or management controller 152 may continue to perform location monitoring and/or location reporting processes (e.g., reporting location data to other devices via out-of-band communications).

Enabling hardware and/or software may also include, for example, sounding an alarm or displaying an alert (e.g., via data processing system 102A). Any functionality may be modified, limited, etc., for a period of time and/or until applicable policies indicate the functionality should be enabled (e.g., when an expected gait pattern is detected during motion analysis process 222).

During policy enforcement process 224, management controller 152 may, for example, disable technology based on trade secrets and/or hardware resources 150 that may limit functionality of data processing system 102A, such as a TPM of data processing system 102A. For example, by disabling the TPM, access to and/or use of secrets stored by the TPM may be prevented. Consequently, data decryption functionality may be lost, signing ability of data structures for device verification may be lost, etc., which may increase the security of data stored by and/or accessible by data processing system 102A.

Modifying the boot process for data processing system 102A may include updating instructions used by and/or providing instructions to the basic input output system (BIOS). For example, the BIOS may verify a use status of data processing system 102A before and/or during performance of a boot process for an operating system installed on data processing system 102A. The use status may be verified by reading boot instructions (e.g., updated by management controller 152) and/or other types of data structures in which the use status may be stored. Based on the boot instructions, different boot paths may be taken. For example, the operating system may not load, portions of the operating system may be loaded, and/or other boot processes may be performed that result in limitations on the functionality of the device.

Once policy enforcement process 224 has completed, the operation of data processing system 102A may be updated to place the data processing system in an elevated security state. Once data processing system 102A is placed in the elevated security state, data previously accessible via data processing system 102A may be inaccessible via data processing system 102A. Thus, while in the elevated security state, potential impacts of undesired use of (e.g., unauthorized access to) data processing system 102A may be mitigated or avoided.

Policy enforcement process 224 may also include obtaining (e.g., generating) a notification. The notification may include any information obtained and/or generated during motion analysis process 222 or policy enforcement process 224. For example, the notification may include (i) a message indicating that, based on the motion data, the gait pattern is unexpected for data processing system 102A, (ii) actions performed and/or policies enforced based on policies triggered by the unexpected gait pattern, and/or (iii) identifying information (e.g., for data processing system 102A and authorized users thereof), (iv) information regarding the gait pattern (e.g., time of unexpected gait pattern and/or parameters of the unexpected gait pattern, motion data used to characterize the gait pattern), and/or (v) other data (e.g., authentication information).

Management controller 152 may provide the notification to other (remote) systems that may, for example, manage security of data processing systems (e.g., 102). For example, the notification may be provided to service systems 104 at interaction 226, using methods similar to those described with respect to interaction 204 of FIG. 2A. The notification may be provided while a portion of hardware resources 150 are inoperable (e.g., due to being unpowered). Therefore, the notification may reach service systems 104 regardless of the status (e.g., unpowered, compromised) of hardware resources 150.

The information included in the notification may be used to identify and/or implement further security measures that may improve the security of the data processing systems. For example, based on the information included in the notification, (i) alerts may be provided to other devices associated with data processing system 102A and/or authorized users of data processing system 102A, (ii) real-time location tracking of data processing system 102A may be enabled (e.g., via a remote device), and/or (iii) security states of a building associated with data processing system 102A and/or the authorized users may be elevated (e.g., an alarm may sound in the building, building entry and/or exit points may be locked).

Thus, as shown in the example of FIG. 2B, operation of a data processing system may be managed based on motion data for the data processing system. The data processing system may collect the motion data (e.g., automatically, in real-time) that may be generated during pedestrian transport of the data processing system. The motion data may be analyzed (e.g., by out-of-band components of the data processing system) in order to identify a gait pattern of a user performing the pedestrian transport. The gait pattern may be classified as expected or unexpected for the data processing system (e.g., based on a predetermined gait signature for the data processing system). When an unexpected gait pattern is detected, a (security) policy of the data processing system may be triggered, and in response, operation of the data processing system may be updated (e.g., by the out-of-band components) according to the policy. By doing so, the modified operation of data processing system may protect the data processing system from undesired use (e.g., unauthorized access to sensitive data via the data processing system may be prevented).

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2B may perform various methods to manage data processing systems based on motion data, using out-of-band components of the data processing systems. By doing so, impacts of unauthorized use of the data processing systems may be managed in a timely manner.

Turning to FIG. 3, a method that may be performed by the components of the system of FIGS. 1A-2B is illustrated. In the diagrams discussed below and shown in FIG. 3, any of the operations may be repeated, performed in different orders, and/or performed in parallel with or in a partially overlapping in time manner with other operations. The method described with respect to FIG. 3 may be performed by a data processing system (e.g., of data processing systems 102), a management controller of the data processing system, hardware resources of the data processing system, other components of the data processing system, and/or another device.

At operation 302, motion data for the data processing system may be obtained. The motion data may be obtained by (i) receiving the motion data from hardware resources of the data processing system and/or another entity via communication by a data processing system, (ii) reading the motion data from storage, and/or (iii) generating the motion data. For example, the motion data may be generated by enabling sensing components of the data processing system to measure and/or record various types of movement of the data processing system.

Obtaining the motion data may include implementing methods similar to those discussed with respect to FIG. 2B (e.g., 222) and/or by other methods. The motion data may be usable to characterize a gait pattern for a person transporting the data processing system while the motion data is obtained. The gait pattern may be unique to the person; therefore, motion data of the data processing system may reflect unauthorized transport of the data processing system (e.g., transport of the data processing system by a person not authorized to access the data processing system).

Prior to obtaining the motion data and/or during a provisioning process for the data processing system, initial motion data for the data processing system may be obtained while a person authorized to transport the data processing system is transporting the data processing system (e.g., the data processing system may be transported via pedestrian transport). The initial motion data may be provided to a remote service system (e.g., via an out-of-band communication channel). The initial motion data may be obtained and/or provided by methods similar to those discussed with respect to FIG. 2A (e.g., 202, 204) and/or by other methods.

A gait signature based on the initial motion data (e.g., generated, by the remote service system, using the initial motion data) may be obtained. The gait signature may be obtained by (i) receiving the gait signature from the remote server and/or another entity via communication by a data processing system, (ii) reading the gait signature from storage, and/or (iii) generating the gait signature (e.g., locally). For example, the data processing system may perform a gait modeling process using the motion data to generate the gait signature locally (e.g., using local hardware of out-of-band components and/or in-band components of the data processing system).

The gait signature may be generated remotely and therefore may also be obtained (e.g., via the out-of-band communication channel) by methods similar to those discussed with respect to FIG. 2A (e.g., interaction 208) and/or by other methods. The gait signature may include a gait pattern for an authorized user of the data processing system. For more information regarding provisioning processes and/or gait signatures, refer to the discussion of FIG. 2A.

At operation 304, a motion analysis process may be performed using the motion data to determine whether the gait pattern of the motion data is expected for the data processing system. The motion analysis process may be performed by methods similar to those discussed with respect to motion analysis process 222 of FIG. 2B and/or by other methods. For example, the motion analysis process may include obtaining the gait pattern based on the motion data. The gait pattern may be obtained by (i) receiving the gait pattern from another entity via communication by a data processing system, (ii) reading the gait pattern from storage, and/or (iii) generating the gait pattern (e.g., locally, using a gait analysis method that may use the motion data to determine gait parameters such as velocity, cadence, swing time, stride length, etc.)

The motion analysis process may also include comparing the gait pattern to the gait signature, by comparing portions of gait parameters of the gait pattern with the same portions of gait parameters of the gait signature. Comparing the gait pattern to the gait signature may include evaluating a function such as a ratio, a difference, and/or any combination of functions of the gait parameters to obtain a level of similarity. The level of similarity may be compared to a threshold (e.g., a similarity threshold) in order to determine whether to treat the gait pattern as unexpected (or expected) for the data processing system.

At operation 306, a determination may be made regarding whether the gait pattern is expected for the data processing system. The determination may be made by comparing the level of similarity to a similarity threshold. For example, a smaller level of similarity may indicate that the gait pattern and the gait signature are more similar than larger levels of similarity may indicate. Therefore, if the level of similarity exceeds the similarity threshold, then the gait pattern may be treated as unexpected for the data processing system and the method may proceed to operation 308 following operation 306. Otherwise, the method may end following operation 306.

At operation 308, a policy for the data processing system that, at least in part, governs operation of the data processing system may be identified. The policy may be identified by (i) reading the policy from storage, (ii) performing a lookup for the policy (e.g., the lookup being based, at least in part, on the unexpected gait pattern), (iii) querying an entity responsible for managing policies for the data processing system, and/or (iv) by other methods. For example, the policy may be obtained from the remote server, via methods described with respect to FIG. 2B (e.g., interaction 226). The policy may include instructions and/or may specify desired operation of the data processing system based on the unexpected gait pattern.

At operation 310, performance of an action set may be initiated to update operation of the data processing system. Performance of the action set may be initiated by (i) obtaining (e.g., generating) instructions based on the action set, and/or (ii) executing the instructions in order to update the operation of the data processing system (e.g., enabling or disabling hardware and/or software, initiating processes, updating configuration settings, downloading data, installing software, etc.). Refer to the discussion of FIG. 2B for more details regarding performance of action sets.

Performance of the action set (e.g., one or more actions of the action set) may place the data processing system in an elevated security state. The updated operation of the data processing system may render the data processing system more resistant to unauthorized use (e.g., access) than the prior operation of the data processing system.

The method may end following operation 310.

As illustrated above, embodiments disclosed herein may provide systems and methods usable to manage operation of a data processing system in real-time based on its motion data. The motion data may indicate whether the data processing system is likely to be used in an undesired manner (e.g., is at risk of being accessed by an unauthorized user of the data processing system). Thus, operation of the data processing systems may be managed based on the motion data and, in part, by out-of-band components of the data processing system. By doing so, performance of processes for detecting and/or responding to unauthorized transport of the data processing system may not rely on potentially compromised or unpowered in-band components. Thus, the likelihood of effectively managing the security of data accessible via the data processing system may be increased.

The operation of the data processing system may be managed according to policies for the data processing system automatically and/or in real-time, reducing the likelihood of service disruptions, policy violations, and/or security issues that may arise while providing computer-implemented services. Accordingly, the disclosed process provides for both an embodiment in computing technology and an improved method for managing the security of data processing systems.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations.

System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-408 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like.

More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets.

Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
obtaining motion data for the data processing system, the motion data being usable to characterize a gait pattern for a person transporting the data processing system while the motion data is obtained;
performing, at least in part, by a management controller of the data processing system, a motion analysis process using the motion data to determine whether the gait pattern of the motion data is expected for the data processing system; and
in a first instance of the performing of the motion analysis process where it is determined that the gait pattern is not expected for the data processing system:
identifying, by the management controller, a policy for the data processing system that, at least in part, governs operation of the data processing system, and
initiating, by the management controller, performance of an action set based on the policy to update the operation of the data processing system to place the data processing system in an elevated security state.

2. The method of claim 1, further comprising:
prior to obtaining the motion data and during a provisioning process for the data processing system:
obtaining, by the data processing system, initial motion data for the data processing system while a person authorized to transport the data processing system is transporting the data processing system,
providing, by the management controller and via an out-of-band communication channel and to a service system, the initial motion data, and
obtaining, by the management controller and via the out-of-band communication channel and from the service system, a gait signature, the gait signature being based on the initial motion data.

3. The method of claim 2, wherein performing the motion analysis process comprises:
obtaining the gait pattern based on the motion data;
comparing the gait pattern to the gait signature for the data processing system identify a level of similarity between the gait pattern and the gait signature;
making a determination regarding whether the gait pattern is expected for the data processing system based on the level of similarity; and
in a first instance where the level of similarity exceeds a similarity threshold:
treating the gait pattern as unexpected.

4. The method of claim 1, wherein the motion data is obtained using at least one sensing component of the data processing system from a list of sensing components consisting of:
an accelerometer;
a gyroscope;
a magnetometer; and
a global positioning system sensor.

5. The method of claim 1, wherein the action set comprises disabling, by the management controller, a portion of hardware resources of the data processing system.

6. The method of claim 5, wherein the portion of the hardware resources comprises a trusted platform module.

7. The method of claim 1, wherein the action set comprises disabling a piece of software hosted by hardware resources of the data processing system.

8. The method of claim 1, wherein the action set comprises providing, by the management controller and via an out-of-band communication channel and to a service system, a notification indicating that the gait pattern is unexpected.

9. The method of claim 8, wherein the notification is provided while a portion of hardware resources of the data processing system are inoperable.

10. The method of claim 1, wherein the policy is obtained by the management controller via an out-of-band communication channel and from a service system tasked with managing policies for the data processing system.

11. The method of claim 1, wherein when the data processing system is in the elevated security state, data previously accessible via the data processing system is inaccessible via the data processing system.

12. The method of claim 1, wherein the data processing system comprises a network module adapted to separately advertise network endpoints for the management controller and hardware resources of the data processing system, the network endpoints being usable by a service system to address communications to the hardware resources and the management controller.

13. The method of claim 12, wherein an out-of-band communication channel that services the management controller runs through the network module, and an in-band communication channel that services the hardware resources also runs through the network module.

14. The method of claim 12, wherein the management controller and the network module are on separate power domains from the hardware resources so that the management controller and the network module are operable while the hardware resources are inoperable.

15. The method of claim 14, wherein the motion analysis process is performed while a portion of the hardware resources are inoperable due to being unpowered.

16. A non-transitory machine-readable medium having instructions stored therein, which when executed by a processor, cause the processor to perform operations for managing a data processing system, the operations comprising:
obtaining motion data for the data processing system, the motion data being usable to characterize a gait pattern for a person transporting the data processing system while the motion data is obtained;
performing, at least in part, by a management controller of the data processing system, a motion analysis process using the motion data to determine whether the gait pattern of the motion data is expected for the data processing system; and
in a first instance of the performing of the motion analysis process where it is determined that the gait pattern is not expected for the data processing system:
identifying, by the management controller, a policy for the data processing system that, at least in part, governs operation of the data processing system, and
initiating, by the management controller, performance of an action set based on the policy to update the operation of the data processing system to place the data processing system in an elevated security state.

17. The non-transitory machine-readable medium of claim 16, the operations further comprising:
prior to obtaining the motion data and during a provisioning process for the data processing system:
obtaining, by the data processing system, initial motion data for the data processing system while a person authorized to transport the data processing system is transporting the data processing system,
providing, by the management controller and via an out-of-band communication channel and to a service system, the initial motion data, and
obtaining, by the management controller and via the out-of-band communication channel and from the service system, a gait signature, the gait signature being based on the initial motion data.

18. The non-transitory machine-readable medium of claim 17, wherein performing the motion analysis process comprises:
obtaining the gait pattern based on the motion data;
comparing the gait pattern to the gait signature for the data processing system identify a level of similarity between the gait pattern and the gait signature;
making a determination regarding whether the gait pattern is expected for the data processing system based on the level of similarity; and
in a first instance where the level of similarity exceeds a similarity threshold:
treating the gait pattern as unexpected.

19. A data processing system, comprising:
a processor; and
a memory coupled to the processor to store instructions, which when executed by the processor, cause the processor to perform operations for managing the data processing system, the operations comprising:
obtaining motion data for the data processing system, the motion data being usable to characterize a gait pattern for a person transporting the data processing system while the motion data is obtained,
performing, at least in part, by a management controller of the data processing system, a motion analysis process using the motion data to determine whether the gait pattern of the motion data is expected for the data processing system, and
in a first instance of the performing of the motion analysis process where it is determined that the gait pattern is not expected for the data processing system:
identifying, by the management controller, a policy for the data processing system that, at least in part, governs operation of the data processing system; and
initiating, by the management controller, performance of an action set based on the policy to update the operation of the data processing system to place the data processing system in an elevated security state.

20. The data processing system of claim 19, the operations further comprising:
prior to obtaining the motion data and during a provisioning process for the data processing system:
obtaining, by the data processing system, initial motion data for the data processing system while a person authorized to transport the data processing system is transporting the data processing system,
providing, by the management controller and via an out-of-band communication channel and to a service system, the initial motion data, and
obtaining, by the management controller and via the out-of-band communication channel and from the service system, a gait signature, the gait signature being based on the initial motion data.
